(19) United States
(12) Patent Application Publication
(10) Pub. No.: US 2025/0373357 A1
(43) Pub. Date: Dec. 4, 2025

(54) FLEXIBLE TRANSPORT BLOCK SIZE FOR UPLINK GRANTS

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 19/219,342

(22) Filed: May 27, 2025

Related U.S. Application Data
(60) Provisional application No. 63/652,516, filed on May 28, 2024.

(51) Int. Cl. H04L 1/00; H04W 72/1263

(52) U.S. Cl. CPC H04L 1/0006; H04L 1/0009; H04W 72/1263

(57) ABSTRACT

Methods, systems, and devices for wireless communications are described. The described techniques provide for a user equipment (UE) to dynamically apply a scaling factor to a transport block (TB) size implicitly determined by an uplink grant according to a quantity of bits present in a transmission buffer, or according to a power headroom, or both. The UE may transmit a capability report indicating a capability to dynamically adjust a TB size and may receive a message indicating a set of scaling factors available to apply to a first TB size. If the UE receives an uplink grant indicating that the UE is enabled to adjust the TB size, the UE may apply a scaling factor to the first TB size according to whether the quantity of bits ready for transmission at the UE is greater or less than the quantity of bits supported by the first TB size.

### CROSS REFERENCES

The present Application for Patent claims benefit of U.S. Provisional Patent Application No. 63/652,516 by YANG et al., entitled “FLEXIBLE TRANSPORT BLOCK SIZE FOR UPLINK GRANTS,” filed May 28, 2024, assigned to the assignee hereof, and expressly incorporated herein.

### FIELD OF TECHNOLOGY

The following relates to wireless communications, including flexible transport block (TB) size for uplink grants.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Wireless communications systems may support data communications between UEs and network entities. For example, a UE may receive an uplink grant indicating time-frequency resources via which to communicate a data transmission with a network entity.

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a capability report that indicates a capability of the UE to dynamically adjust a transport block (TB) size for an uplink data transmission, receiving, based on transmission of the capability report, a message that indicates a set of multiple scaling factors that are applicable to scale a first TB size, receiving an uplink grant that schedules the uplink data transmission in accordance with the first TB size and that indicates whether the UE is enabled to adjust the first TB size for the uplink data transmission, and transmitting the uplink data transmission in accordance with a second TB size, where the second TB size is based on application of a first scaling factor of the set of multiple scaling factors to the first TB size.

A UE for wireless communications is described. The UE may include one or more memories storing processor executable code, and one or more processors coupled with the one or more memories. The one or more processors may individually or collectively be operable to execute the code to cause the UE to transmit a capability report that indicates a capability of the UE to dynamically adjust a TB size for an uplink data transmission, receive, based on transmission of the capability report, a message that indicates a set of multiple scaling factors that are applicable to scale a first TB size, receive an uplink grant that schedules the uplink data transmission in accordance with the first TB size and that indicates whether the UE is enabled to adjust the first TB size for the uplink data transmission, and transmit the uplink data transmission in accordance with a second TB size, where the second TB size is based on application of a first scaling factor of the set of multiple scaling factors to the first TB size.

Another UE for wireless communications is described. The UE may include means for transmitting a capability report that indicates a capability of the UE to dynamically adjust a TB size for an uplink data transmission, means for receiving, based on transmission of the capability report, a message that indicates a set of multiple scaling factors that are applicable to scale a first TB size, means for receiving an uplink grant that schedules the uplink data transmission in accordance with the first TB size and that indicates whether the UE is enabled to adjust the first TB size for the uplink data transmission, and means for transmitting the uplink data transmission in accordance with a second TB size, where the second TB size is based on application of a first scaling factor of the set of multiple scaling factors to the first TB size.

A non-transitory computer-readable medium storing code for wireless communications is described. The code may include instructions executable by one or more processors to transmit a capability report that indicates a capability of the UE to dynamically adjust a TB size for an uplink data transmission, receive, based on transmission of the capability report, a message that indicates a set of multiple scaling factors that are applicable to scale a first TB size, receive an uplink grant that schedules the uplink data transmission in accordance with the first TB size and that indicates whether the UE is enabled to adjust the first TB size for the uplink data transmission, and transmit the uplink data transmission in accordance with a second TB size, where the second TB size is based on application of a first scaling factor of the set of multiple scaling factors to the first TB size.

In some examples of the method, user equipment (UEs), and non-transitory computer-readable medium described herein, transmitting the uplink data transmission may include operations, features, means, or instructions for multiplexing uplink control information with the uplink data transmission, or puncturing the uplink control information onto the uplink data transmission, where the uplink control information indicates the first scaling factor.

In some examples of the method, user equipment (UEs), and non-transitory computer-readable medium described herein, the uplink grant indicates that the UE may be enabled to adjust the first TB size for the uplink data transmission and the method, apparatuses, and non-transitory computer-readable medium may include further operations, features, means, or instructions for selecting the first scaling factor from the set of multiple scaling factors based on a quantity of bits present in a transmission buffer, or power headroom, or both, of the UE.

In some examples of the method, user equipment (UEs), and non-transitory computer-readable medium described herein, selecting the first scaling factor may include operations, features, means, or instructions for selecting the first scaling factor based on a difference between the quantity of bits present in the transmission buffer and a second quantity of bits associated with the first TB size, a transmission power associated with the uplink data transmission, a predicted uplink block error rate associated with the uplink data transmission, a transmission power headroom associated with the UE, or any combination thereof.

In some examples of the method, user equipment (UEs), and non-transitory computer-readable medium described herein, the second TB size may be smaller than the first TB size when the uplink data transmission includes a quantity of bits that may be less than the first TB size; and the second TB size may be greater than the first TB size when the uplink data transmission includes a quantity of bits that may be greater than the first TB size.

In some examples of the method, user equipment (UEs), and non-transitory computer-readable medium described herein, the set of multiple scaling factors include a first subset of scaling factors that reduce the first TB size, a second subset of scaling factors that increase the first TB size, or both.

In some examples of the method, user equipment (UEs), and non-transitory computer-readable medium described herein, the uplink grant indicates that the UE may be not enabled to adjust the first TB size for the uplink data transmission and the second TB size may be equal to the first TB size.

In some examples of the method, user equipment (UEs), and non-transitory computer-readable medium described herein, the first TB size may be determined according to one or more parameters indicated in the first uplink grant, the one or more parameters including one or more time domain resources, one or more frequency domain resources, a modulation order, a coding rate, a multiple-in multiple-out (MIMO) layer, or any combination thereof.

In some examples of the method, user equipment (UEs), and non-transitory computer-readable medium described herein, the application of the first scaling factor may include operations, features, means, or instructions for modifying a coding rate, a quantity of resource elements, or both, associated with the first TB size in accordance with the first scaling factor while retaining one or more parameters indicated in the uplink grant, the one or more parameters comprising one or more time domain resources, one or more frequency domain resources, a modulation order, a MIMO layer, or any combination thereof.

A method for wireless communications by a network entity is described. The method may include obtaining, from a UE, a capability report that indicates a capability of the UE to dynamically adjust a TB size for an uplink data transmission, outputting, based on acquisition of the capability report, a message that indicates a set of multiple scaling factors that are applicable to scale a first TB size, outputting an uplink grant that schedules the uplink data transmission in accordance with the first TB size and that indicates whether the UE is enabled to adjust the first TB size for the uplink data transmission, and obtaining the uplink data transmission in accordance with a second TB size, where the second TB size is based on application, by the UE, of a first scaling factor of the set of multiple scaling factors to the first TB size.

A network entity for wireless communications is described. The network entity may include one or more memories storing processor executable code, and one or more processors coupled with the one or more memories. The one or more processors may individually or collectively be operable to execute the code to cause the network entity to obtain, from a UE, a capability report that indicates a capability of the UE to dynamically adjust a TB size for an uplink data transmission, output, based on acquisition of the capability report, a message that indicates a set of multiple scaling factors that are applicable to scale a first TB size, output an uplink grant that schedules the uplink data transmission in accordance with the first TB size and that indicates whether the UE is enabled to adjust the first TB size for the uplink data transmission, and obtain the uplink data transmission in accordance with a second TB size, where the second TB size is based on application, by the UE, of a first scaling factor of the set of multiple scaling factors to the first TB size.

Another network entity for wireless communications is described. The network entity may include means for obtaining, from a UE, a capability report that indicates a capability of the UE to dynamically adjust a TB size for an uplink data transmission, means for outputting, based on acquisition of the capability report, a message that indicates a set of multiple scaling factors that are applicable to scale a first TB size, means for outputting an uplink grant that schedules the uplink data transmission in accordance with the first TB size and that indicates whether the UE is enabled to adjust the first TB size for the uplink data transmission, and means for obtaining the uplink data transmission in accordance with a second TB size, where the second TB size is based on application, by the UE, of a first scaling factor of the set of multiple scaling factors to the first TB size.

A non-transitory computer-readable medium storing code for wireless communications is described. The code may include instructions executable by one or more processors to obtain, from a UE, a capability report that indicates a capability of the UE to dynamically adjust a TB size for an uplink data transmission, output, based on acquisition of the capability report, a message that indicates a set of multiple scaling factors that are applicable to scale a first TB size, output an uplink grant that schedules the uplink data transmission in accordance with the first TB size and that indicates whether the UE is enabled to adjust the first TB size for the uplink data transmission, and obtain the uplink data transmission in accordance with a second TB size, where the second TB size is based on application, by the UE, of a first scaling factor of the set of multiple scaling factors to the first TB size.

In some examples of the method, network entities, and non-transitory computer-readable medium described herein, obtaining the uplink data transmission may include operations, features, means, or instructions for obtaining the uplink data transmission multiplexed with uplink control information, or punctured by the uplink control information, where the uplink control information indicates the first scaling factor.

In some examples of the method, network entities, and non-transitory computer-readable medium described herein, obtaining the uplink data transmission may include operations, features, means, or instructions for decoding the uplink control information to identify the first scaling factor and decoding the uplink data transmission in accordance with the second TB size based on identifying the first scaling factor.

In some examples of the method, network entities, and non-transitory computer-readable medium described herein, the uplink grant indicates that the UE may be enabled to adjust the first TB size for the uplink data transmission based on satisfaction of a threshold value by a percentage of padding bits included in one or more previous uplink data transmissions.

In some examples of the method, network entities, and non-transitory computer-readable medium described herein, the second TB size may be smaller than the first TB size when the uplink data transmission includes a quantity of bits that may be less than the first TB size; and the second TB size may be greater than the first TB size when the uplink data transmission includes a quantity of bits that may be greater than the first TB size.

In some examples of the method, network entities, and non-transitory computer-readable medium described herein, the message may be a radio resource control message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports flexible transport block (TB) size for uplink grants in accordance with one or more aspects of the present disclosure.

FIG. 2 shows an example of a process flow that supports flexible TB size for uplink grants in accordance with one or more aspects of the present disclosure.

FIGS. 3 and 4 show block diagrams of devices that support flexible TB size for uplink grants in accordance with one or more aspects of the present disclosure.

FIG. 5 shows a block diagram of a communications manager that supports flexible TB size for uplink grants in accordance with one or more aspects of the present disclosure.

FIG. 6 shows a diagram of a system including a device that supports flexible TB size for uplink grants in accordance with one or more aspects of the present disclosure.

FIGS. 7 and 8 show block diagrams of devices that support flexible TB size for uplink grants in accordance with one or more aspects of the present disclosure.

FIG. 9 shows a block diagram of a communications manager that supports flexible TB size for uplink grants in accordance with one or more aspects of the present disclosure.

FIG. 10 shows a diagram of a system including a device that supports flexible TB size for uplink grants in accordance with one or more aspects of the present disclosure.

FIGS. 11 and 12 show flowcharts illustrating methods that support flexible TB size for uplink grants in accordance with one or more aspects of the present disclosure.

### DETAILED DESCRIPTION

In some wireless communications systems, to communicate uplink data via a physical uplink shared channel (PUSCH) transmission, the PUSCH transmission may be granted (e.g., scheduled) by a network entity. For example, the network entity may transmit a dynamic grant (DG) or a configured grant (CG) to a user equipment (UE) indicating time-frequency resources for the UE to use for transmitting data via a PUSCH message. In some cases, the grant may indicate a transport block (TB) size associated with the data transmission (e.g., a quantity of bits or amount of information available for the PUSCH transmission). The UE may indicate a status of a buffer at the UE (e.g., an amount of information ready for transmission by the UE) in a buffer status report (BSR) sent to the network entity. For example, the UE may append a BSR to a PUSCH transmission, which may support the network entity configuring a TB size for a subsequent uplink grant. However, in some cases, the network entity may be unaware of the status of the buffer of the UE when configuring a TB size for an uplink grant (e.g., prior to receiving a first BSR from the UE or between receiving BSRs from the UE). In such cases, the network entity may configure a TB size for an uplink transmission that is smaller than the amount of data ready at the UE, which may incur additional latency (e.g., the UE may skip the granted transmission occasion and the network entity may transmit a subsequent grant for the uplink transmission). Alternatively, the network entity may configure a TB size for the uplink transmission that is larger than the amount of data ready at the UE, which may result in relatively large quantities of padding bits in the uplink transmission (e.g., reducing resource utilization efficiency and thereby increasing signaling overhead).

Techniques described herein may support a UE applying a scaling factor to a TB size (e.g., implicitly determined by an uplink grant) according to a quantity of bits present in a transmission buffer of the UE (e.g., a size of a PUSCH data transmission), or according to a power headroom of the UE, or both. In some cases, the UE may transmit a capability report to a network entity indicating a capability of the UE to dynamically adjust a TB size for uplink data transmissions, and the network entity may transmit a message indicating a set of scaling factors available for the UE to apply to a first TB size (e.g., a TB size indicated by a grant, which may be a default TB size). In one or more subsequent uplink grants, the network entity may include an indication of whether a respective grant enables adjusting the first TB size. For example, if the network entity determines that one or more previous TBs received from the UE include a percentage of padding bits that satisfies a threshold value (e.g., a threshold percentage of padding bits, such as 60% to 90% padding observed in prior TBs), the network entity may determine to enable adjusting the TB size for an uplink grant. If the network entity indicates, in an uplink grant, that the UE is enabled to adjust the TB size for an uplink data transmission, the UE may apply a scaling factor (e.g., dynamically) to the first TB size according to whether the quantity of bits ready for transmission at the UE is greater or less than the quantity of bits supported by the first TB size. Such techniques may reduce latency, power expenditure, or both at the UE as well as increasing uplink throughput by the UE, thereby improving overall performance by the UE when communicating uplink data.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to flexible TB size for uplink grants.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

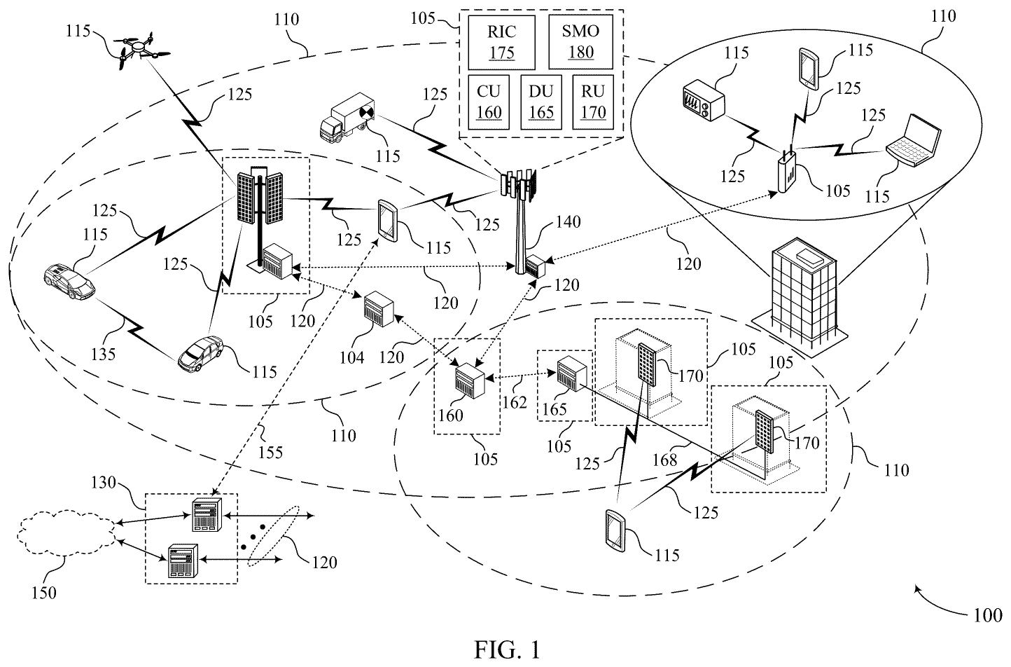

FIG. 1 shows an example of a wireless communications system 100 that supports flexible TB size for uplink grants in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element (e.g., a basial radio resource unit) may refer to resources of one symbol period (e.g., a duration of one modulation symbol) in the time domain and one subcarrier in the frequency domain, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-in multiple-out (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of the wireless communications system 100, to communicate data via a PUSCH transmission, the PUSCH transmission may be granted (e.g., scheduled) by a network entity 105. For example, the network entity 105 may transmit a grant to a UE 115 indicating time-frequency resources for the UE 115 to use for transmitting uplink data via a PUSCH. In some cases, the grant may indicate a TB size associated with the data transmission (e.g., a quantity of bits or amount of information available for the PUSCH transmission). The UE 115 may indicate a status of a buffer at the UE 115 (e.g., an amount of information ready for transmission by the UE 115) in a BSR sent to the network entity 105. For example, the UE 115 may append a BSR to a PUSCH transmission, which may support the network entity 105 configuring a TB size for a subsequent uplink grant. However, in some cases, the network entity 105 may be unaware of the status of the buffer of the UE 115 when configuring a TB size for an uplink grant (e.g., prior to receiving a first BSR from the UE 115 or between receiving BSRs from the UE 115). In such cases, the network entity 105 may configure a TB size for an uplink transmission that is smaller than the amount of data ready at the UE 115, which may incur additional latency (e.g., the UE 115 may skip the granted transmission occasion and the network entity 105 may transmit a subsequent grant for the uplink transmission). Alternatively, the network entity 105 may configure a TB size for the uplink transmission that is larger than the amount of data ready at the UE 115, which may result in relatively large quantities of padding bits in the uplink transmission (e.g., reducing resource utilization efficiency and thereby increasing signaling overhead).

Techniques described herein may support a UE 115 applying a scaling factor to a TB size according to a quantity of bits present in a transmission buffer of the UE 115 (e.g., a size of a PUSCH data transmission), or power headroom, of the UE 115. In some cases, the UE 115 may transmit a capability report to a network entity 105 indicating a capability of the UE 115 to dynamically adjust a TB size for uplink data transmissions, and the network entity 105 may transmit a message indicating a set of scaling factors available for the UE 115 to apply to a first TB size (e.g., a TB size indicated by a grant, which may be a default TB size). In one or more subsequent uplink grants, the network entity 105 may include an indication of whether a respective grant enables adjusting the first TB size. For example, if the network entity 105 determines that one or more previous TBs received from the UE 115 include a percentage of padding bits that satisfies a threshold value (e.g., a threshold percentage of padding bits, such as 60% to 90% padding observed in prior TBs), the network entity 105 may determine to enable adjusting the TB size for an uplink grant. If the network entity 105 indicates, in an uplink grant, that the UE 115 is enabled to adjust the TB size for an uplink data transmission, the UE 115 may apply a scaling factor (e.g., dynamically) to the first TB size according to whether the quantity of bits ready for transmission at the UE 115 is greater or less than the quantity of bits supported by the first TB size. Such techniques may reduce latency, power expenditure, or both at the UE 115 as well as increasing uplink throughput by the UE 115, thereby improving overall performance by the UE 115 when communicating uplink data

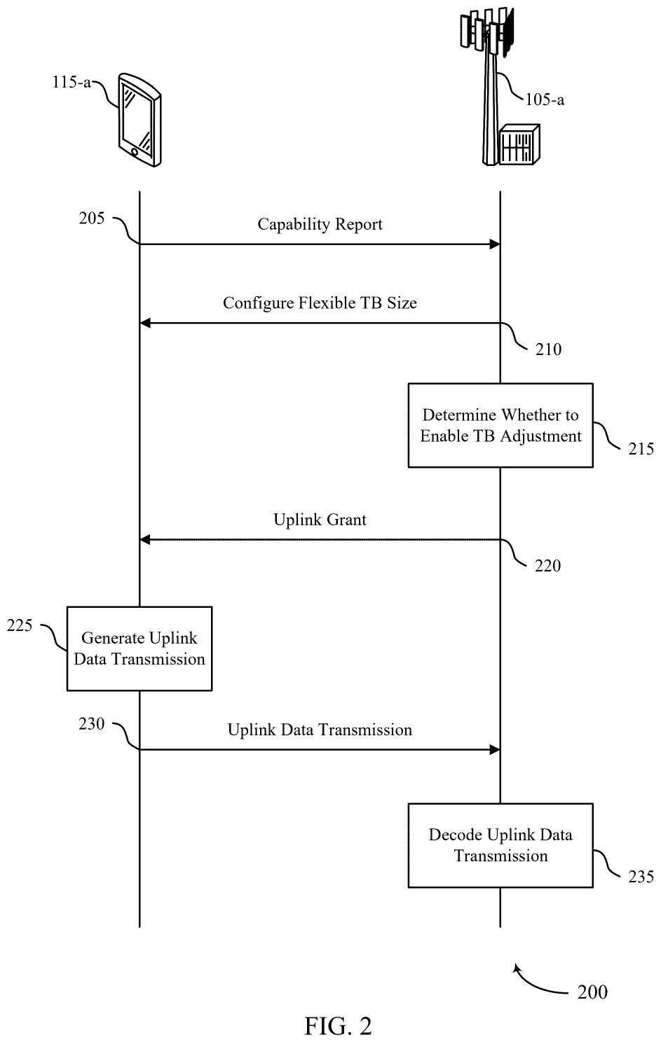

FIG. 2 shows an example of a process flow 200 that supports flexible TB size for uplink grants in accordance with one or more aspects of the present disclosure. The process flow 200 may implement, or be implemented by, one or more aspects of the wireless communications system 100. For example, the process flow 200 may show signaling between a UE 115-a and a network entity 105-a, which may be examples of corresponding devices described with reference to FIG. 1. In some examples, the process flow 200 may support the UE 115-a communicating an uplink data transmission via a TB size that is scaled relative to a TB size (e.g., determined implicitly based on one or more parameters indicated by the network entity 105-a). Alternative examples of the following may be implemented, where some processes are performed in a different order than described or are not performed. In some cases, processes may include additional features not mentioned below, or further processes may be added.

At 205, the UE 115-a may transmit a capability report to the network entity 105-a. In some cases, the capability report may indicate a capability of the UE 115-a to adjust (e.g., dynamically) a TB size for one or more uplink data transmissions. For example, the UE 115-a may indicate, in the capability report, that the UE 115-a supports flexible TB sizing for transmitting uplink data via PUSCH transmissions. Additionally, or alternatively, the capability report may indicate a range of TB sizes (e.g., an upper bound TB size and a lower bound TB size) supported by the UE 115-a or may indicate a quantity of scaling factors which are supported by the UE 115-a for re-sizing a TB, or both.

At 210, the network entity 105-a may transmit a message to the UE 115-a that indicates a set of multiple scaling factors applicable for scaling a first TB size. In some examples, the first TB size may be a default TB size configured for uplink data transmissions. Additionally, or alternatively, the first TB size may be associated with one or more communication parameters of an uplink data transmission, which may be indicated in an uplink grant scheduling the uplink data transmission. The set of multiple scaling factors may include a first subset of one or more scaling factors that reduce the first TB size (e.g., 0.25, 0.5, 0.75, or the like) and may include a second subset of one or more scaling factors that increase the first TB size (e.g., 1.25, 1.5, 1.75, or the like). In some cases, the quantity of scaling factors included in the set of multiple scaling factors may be associated with a quantity of scaling factors supported by the UE 115-a (e.g., indicated in the capability report).

As the TB size is generally a function of other factors, including a modulation and coding scheme (MCS), the sets of multiple scaling factors may be associated with different MCS ranges. For example, the MCS range may include an MCS associated with the first TB size and may include respective MCSs associated with an application of each scaling factor of the set of scaling factors to the first TB size.

At 215, the network entity 105-a may determine whether to enable TB size adjustment for a subsequent uplink data transmission from the UE 115-a. In some cases, the network entity 105-a may determine whether to enable the UE 115-a to adjust the first TB size for the uplink data transmission according to one or more previous uplink data transmissions (e.g., received by the network entity 105-a from the UE 115-a, one or more other UEs 115, or both). For example, the network entity 105-a may determine a percentage of padding bits included in the one or more previous uplink data transmissions and may compare the percentage of padding bits with a threshold value. In some examples, the network entity 105-a may observe relatively high percentages of padding bits included in uplink data transmissions due to high variation associated with uplink traffic, which may be exacerbated when the uplink data transmissions are granted by pre-scheduled grants (e.g., greater than 90% padding), such as grants for periodic or semi-persistent uplink data transmissions.

Such padding bits may occur when the uplink data transmission includes less data than the TB size indicated by a corresponding grant, and may increase interference and power consumption at a transmitting UE 115. For example, the pre-scheduled grants may indicate the first TB size that is configured for multiple uplink data transmissions and may not account for a current amount of data ready for transmission by the UE 115-a (e.g., the first TB size may be statically defined for a set of uplink grants). In some cases, if the network entity 105-a determines that the percentage of padding bits in the one or more previous uplink data transmissions satisfies the threshold value, the network entity 105-a may determine to enable TB size adjustment for the subsequent uplink data transmission (e.g., to prevent the transmission from including a relatively high quantity of padding bits). Alternatively, if the network entity 105-a determines that the percentage of padding bits in the one or more previous uplink data transmissions fails to satisfy the threshold value, the network entity 105-a may determine to not enable TB size adjustment for the subsequent uplink data transmission.

At 220, the network entity 105-a may transmit an uplink grant to the UE 115-a. The uplink grant may schedule an uplink data transmission according to the first TB size and may include an indication of whether the UE 115-a is enabled to adjust the first TB size for the uplink data transmission (e.g., according to the determination by the network entity 105-a at step 215 of the process flow 200). For example, the network entity 105-a may indicate, in the uplink grant, that the UE 115-a is enabled to adjust the first TB size for the uplink transmission or that the UE 115-a is not enabled to adjust the first TB size for the uplink transmission. In some cases, the uplink grant (or another message) may include one or more communication parameters for the uplink data transmission, and the first TB size may be determined according to the one or more communication parameters (e.g., determined implicitly using the one or more communication parameters). The one or more communication parameters may include one or more time domain resources for the uplink data transmission, one or more frequency domain resources for the uplink data transmission, a modulation order for the uplink data transmission, a coding rate for the uplink data transmission, a MIMO layer for the uplink data transmission, or any combination thereof. For example, the TB size may be based on an intermediate quantity of information bits (e.g., quantized by a quantizer) associated with a radio resource allocation, which may be associated with one or more of a quantity of resource elements (e.g., based on a quantity of resource blocks (RBs) and a quantity of symbols or a transmission duration), a modulation order, a code rate (e.g., associated with an MCS field and an MCS table), and a quantity of layers.

At 225, the UE 115-a may generate the uplink data transmission. In some cases, as part of generating the uplink data transmission, the UE 115-a may scale the first TB size to a second TB size according to whether adjusting the TB size is enabled for the uplink data transmission. For example, if the uplink grant indicated that the UE 115-a is not enabled to adjust the first TB size for the uplink data transmission, the UE 115-a may refrain from scaling the first TB size (e.g., refrain from applying a scaling factor or apply a scaling factor of 1 such that the first TB size and the second TB size are the same). Alternatively, if the uplink grant indicated that the UE 115-a is enabled to adjust the first TB size for the uplink data transmission, the UE 115-a may select a first scaling factor from the set of multiple scaling factors to apply to the first TB size. The UE 115-a may apply the first scaling factor to the first TB size to obtain as second TB size. In some examples, the UE 115-a may select the first scaling factor from the set of multiple scaling factors according to a quantity of bits present in a transmission buffer, or power headroom, of the UE 115-a. For example, the UE 115-a may determine whether the quantity of bits present in the transmission buffer (e.g., a quantity of bits available to include in the uplink data transmission) is less than or greater than a second quantity of bits granted by the uplink grant (e.g., a quantity of bits associated with the first TB size).

As an example, the UE 115-a may determine that the quantity of bits present in the transmission buffer is greater than the quantity of bits associated with the first TB size (e.g., the uplink grant is not sufficient to accommodate data in the transmission buffer) and may select a scaling factor that increases the first TB size to the second TB size (e.g., the second TB size is greater than the first TB size). By increasing the size of the TB, the UE 115-a may prevent receiving another uplink grant for transmitting the data, thereby reducing signaling overhead and power consumption in the system. As another example, the UE 115-a may determine that the quantity of bits present in the transmission buffer is less than the quantity of bits associated with the first TB size (e.g., the uplink grant is larger than the data in the transmission buffer) and may select a scaling factor that decreases the first TB size to the second TB size (e.g., the second TB size is less than the first TB size). By decreasing the size of the TB, the UE 115-a may prevent the uplink data transmission from including relatively high quantities of padding bits. In some examples, the UE 115-a may apply the first scaling factor to the first TB size by modifying a coding rate, or a quantity of resource elements, or both, associated with the first TB size according to the first scaling factor. In some examples, the UE 115-a may modify the coding rate while retaining (e.g., using one or more associated values that may be previously configured or indicated) one or more parameters indicated in the uplink grant (e.g., the one or more communication parameters), the one or more parameters including one or more time domain resources, one or more frequency domain resources, a modulation order, a MIMO layer, or any combination thereof. For example, the UE 115-a may increase the coding rate for the uplink data transmission if the UE 115-a determines to increase the first TB size and may decrease the coding rate for the uplink data transmission if the UE 115-a determines to decrease the first TB size.

In some cases, the UE 115-a may consider one or more additional factors (e.g., other than the status of the transmission buffer) when selecting a scaling factor to apply to the first TB size. For example, the UE 115-a may select the first scaling factor based on a transmission power associated with the uplink data transmission, a predicted uplink block error rate associated with the uplink data transmission, a transmission power headroom associated with the UE 115-a (e.g., the UE 115-a may increase the TB size if the UE 115-a has available power headroom), or any combination thereof.

In some examples, as part of generating the uplink data transmission, the UE 115-a may generate uplink control information (UCI) to transmit with the uplink data transmission. For example, the UE 115-a may multiplex the UCI with the uplink data transmission. Additionally, or alternatively, the UE 115-a may puncture the UCI onto the uplink data transmission. In some cases, the UCI may indicate the TB size scaling factor (e.g., a TB size (TBS)-UCI) selected for the uplink data transmission on a per-slot basis. For example, the UE 115-a may include, in the UCI, an indication of the first scaling factor applied to the first TB size, which may support the network entity 105-a successfully decoding the TB having the second TB size.

At 230, the UE 115-a may transmit the uplink data transmission to the network entity 105-a. For example, the UE 115-a may transmit the uplink data transmission including the TBS-UCI multiplexed with the TB (or punctured onto the TB) having the second TB size (which may be greater than, the same, or less than the first TB size indicated in the uplink grant). In some cases, the second TB size may be based on an application, by the UE 115-a, of the first scaling factor to the first TB size.

At 235, the network entity 105-a may decode the uplink data transmission. For example, the network entity 105-a may initially decode the TBS-UCI (e.g., demultiplex the control information from the data, extracting the control information from the data) to identify the first scaling factor applied to the first TB size. The network entity 105-a may perform de-rate matching based on the first scaling factor and the first TB size to support decoding the TB having the second TB size (e.g., decoding the data via the second TB size and based on the first scaling factor). For example, the network entity 105-a may decode the PUSCH data transmission after decoding the UCI based on identifying the first scaling factor.

Such techniques may reduce signaling overhead and uplink interference while increasing uplink throughput, thereby improving overall performance of uplink communications, by enabling the UE 115-a to dynamically adjust TB sizes according to current communication parameters and availability of transmission data.

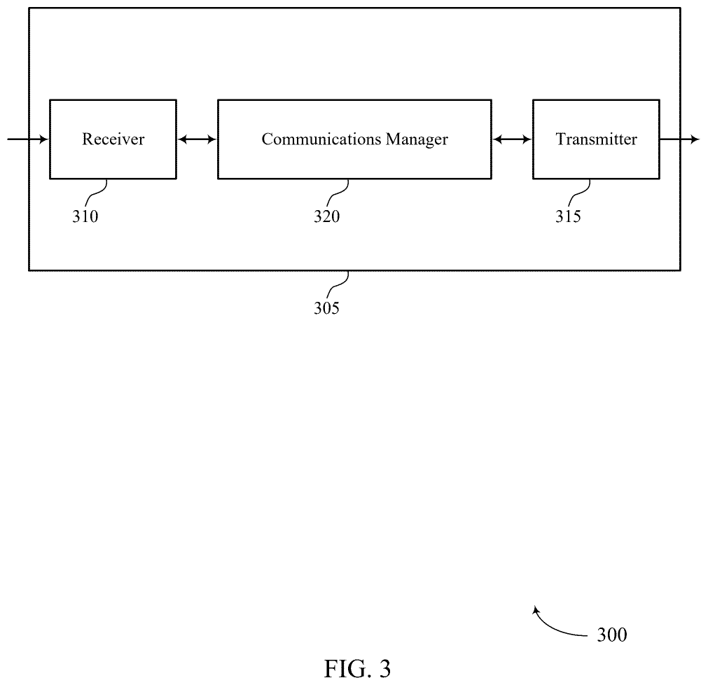

FIG. 3 shows a block diagram 300 of a device 305 that supports flexible TB size for uplink grants in accordance with one or more aspects of the present disclosure. The device 305 may be an example of aspects of a UE 115 as described herein. The device 305 may include a receiver 310, a transmitter 315, and a communications manager 320. The device 305, or one or more components of the device 305 (e.g., the receiver 310, the transmitter 315, the communications manager 320), may include at least one processor, which may be coupled with at least one memory, to, individually or collectively, support or enable the described techniques. Each of these components may be in communication with one another (e.g., via one or more buses).

Further, various components of the device 305 may provide means for performing the methods described herein. In some examples, means for transmitting and/or receiving may include the transceivers and/or antenna(s) of the device 305. In some examples, means for outputting or sending (such as means for outputting for transmission) and means for obtaining (such as means for obtaining after information is received from a different device) may include one or more interfaces of the 305 to output signals to other components or obtain signals from other components of the device 305. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. Each of means for applying, means for multiplexing, means for puncturing, means for selecting, means for modifying, and/or means for using, include a processing system, processor circuitry (including one or more processors), memory circuitry, and/or computer-readable media of the device 305.

The receiver 310 may provide a means for receiving information such as packets, user data, control information, or any combination thereof associated with various information channels (e.g., control channels, data channels, information channels related to flexible TB size for uplink grants). Information may be passed on to other components of the device 305. The receiver 310 may utilize a single antenna or a set of multiple antennas.

The transmitter 315 may provide a means for transmitting signals generated by other components of the device 305. For example, the transmitter 315 may transmit information such as packets, user data, control information, or any combination thereof associated with various information channels (e.g., control channels, data channels, information channels related to flexible TB size for uplink grants). In some examples, the transmitter 315 may be co-located with a receiver 310 in a transceiver module. The transmitter 315 may utilize a single antenna or a set of multiple antennas.

The communications manager 320, the receiver 310, the transmitter 315, or various combinations or components thereof may be examples of means for performing various aspects of flexible TB size for uplink grants as described herein. For example, the communications manager 320, the receiver 310, the transmitter 315, or various combinations or components thereof may be capable of performing one or more of the functions described herein.

In some examples, the communications manager 320, the receiver 310, the transmitter 315, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 320, the receiver 310, the transmitter 315, or various combinations or components thereof may be implemented in code (e.g., as communications management software or firmware) executed by at least one processor (e.g., referred to as a processor-executable code). If implemented in code executed by at least one processor, the functions of the communications manager 320, the receiver 310, the transmitter 315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 320 may be configured to perform various operations (e.g., receiving, obtaining, monitoring, outputting, transmitting) using or otherwise in cooperation with the receiver 310, the transmitter 315, or both. For example, the communications manager 320 may receive information from the receiver 310, send information to the transmitter 315, or be integrated in combination with the receiver 310, the transmitter 315, or both to obtain information, output information, or perform various other operations as described herein.

The communications manager 320 may support wireless communications in accordance with examples as disclosed herein. For example, the communications manager 320 is capable of, configured to, or operable to support a means for transmitting a capability report that indicates a capability of the UE to dynamically adjust a TB size for an uplink data transmission. The communications manager 320 is capable of, configured to, or operable to support a means for receiving, based on transmission of the capability report, a message that indicates a set of multiple scaling factors that are applicable to scale a first TB size. The communications manager 320 is capable of, configured to, or operable to support a means for receiving an uplink grant that schedules the uplink data transmission in accordance with the first TB size and that indicates whether the UE is enabled to adjust the first TB size for the uplink data transmission. The communications manager 320 is capable of, configured to, or operable to support a means for transmitting the uplink data transmission in accordance with a second TB size, where the second TB size is based on application of a first scaling factor of the set of multiple scaling factors to the first TB size.

By including or configuring the communications manager 320 in accordance with examples as described herein, the device 305 (e.g., at least one processor controlling or otherwise coupled with the receiver 310, the transmitter 315, the communications manager 320, or a combination thereof) may support techniques for reduced signaling overhead and uplink interference and increased uplink throughput, thereby improving overall performance of uplink communications.

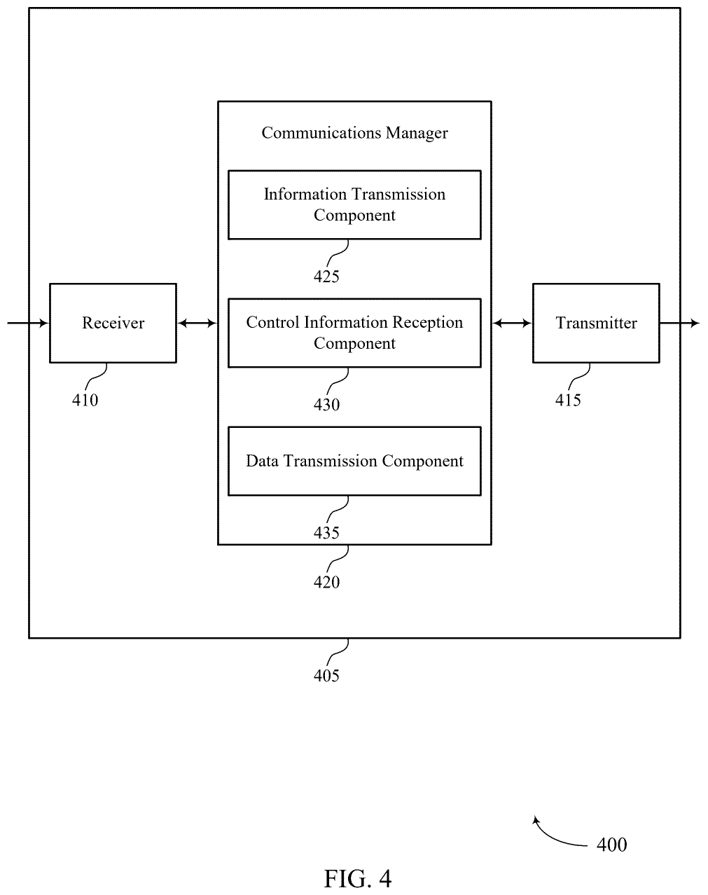

FIG. 4 shows a block diagram 400 of a device 405 that supports flexible TB size for uplink grants in accordance with one or more aspects of the present disclosure. The device 405 may be an example of aspects of a device 305 or a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to support the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to flexible TB size for uplink grants). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to flexible TB size for uplink grants). In some examples, the transmitter 415 may be co-located with a receiver 410 in a transceiver module. The transmitter 415 may utilize a single antenna or a set of multiple antennas.

The device 405, or various components thereof, may be an example of means for performing various aspects of flexible TB size for uplink grants as described herein. For example, the communications manager 420 may include an information transmission component 425, a control information reception component 430, a data transmission component 435, or any combination thereof. The communications manager 420 may be an example of aspects of a communications manager 320 as described herein. In some examples, the communications manager 420, or various components thereof, may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. The information transmission component 425 is capable of, configured to, or operable to support a means for transmitting a capability report that indicates a capability of the UE to dynamically adjust a TB size for an uplink data transmission. The control information reception component 430 is capable of, configured to, or operable to support a means for receiving, based on transmission of the capability report, a message that indicates a set of multiple scaling factors that are applicable to scale a first TB size. The control information reception component 430 is capable of, configured to, or operable to support a means for receiving an uplink grant that schedules the uplink data transmission in accordance with the first TB size and that indicates whether the UE is enabled to adjust the first TB size for the uplink data transmission. The data transmission component 435 is capable of, configured to, or operable to support a means for transmitting the uplink data transmission in accordance with a second TB size, where the second TB size is based on application of a first scaling factor of the set of multiple scaling factors to the first TB size.

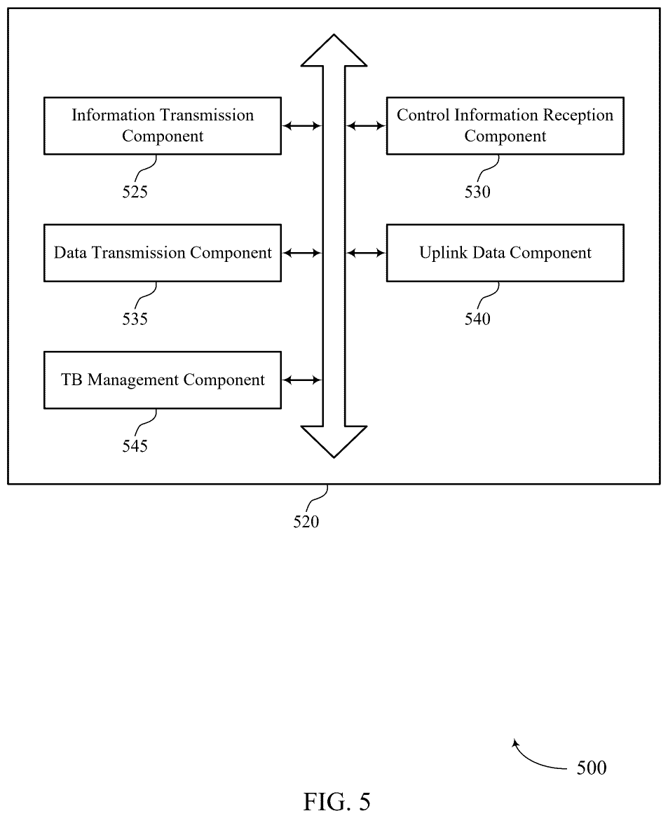

FIG. 5 shows a block diagram 500 of a communications manager 520 that supports flexible TB size for uplink grants in accordance with one or more aspects of the present disclosure. The communications manager 520 may be an example of aspects of a communications manager 320, a communications manager 420, or both, as described herein. The communications manager 520, or various components thereof, may be an example of means for performing various aspects of flexible TB size for uplink grants as described herein. For example, the communications manager 520 may include an information transmission component 525, a control information reception component 530, a data transmission component 535, an uplink data component 540, a TB management component 545, or any combination thereof. Each of these components, or components or subcomponents thereof (e.g., one or more processors, one or more memories), may communicate, directly or indirectly, with one another (e.g., via one or more buses).

The communications manager 520 may support wireless communications in accordance with examples as disclosed herein. The information transmission component 525 is capable of, configured to, or operable to support a means for transmitting a capability report that indicates a capability of the UE to dynamically adjust a TB size for an uplink data transmission. The control information reception component 530 is capable of, configured to, or operable to support a means for receiving, based on transmission of the capability report, a message that indicates a set of multiple scaling factors that are applicable to scale a first TB size. In some examples, the control information reception component 530 is capable of, configured to, or operable to support a means for receiving an uplink grant that schedules the uplink data transmission in accordance with the first TB size and that indicates whether the UE is enabled to adjust the first TB size for the uplink data transmission. The data transmission component 535 is capable of, configured to, or operable to support a means for transmitting the uplink data transmission in accordance with a second TB size, where the second TB size is based on application of a first scaling factor of the set of multiple scaling factors to the first TB size.

In some examples, to support transmitting the uplink data transmission, the uplink data component 540 is capable of, configured to, or operable to support a means for multiplexing uplink control information with the uplink data transmission, or puncturing the uplink control information onto the uplink data transmission, where the uplink control information indicates the first scaling factor.

In some examples, the uplink grant indicates that the UE is enabled to adjust the first TB size for the uplink data transmission, and the TB management component 545 is capable of, configured to, or operable to support a means for selecting the first scaling factor from the set of multiple scaling factors based on a quantity of bits present in a transmission buffer, or power headroom, of the UE.

In some examples, to support selecting the first scaling factor, the TB management component 545 is capable of, configured to, or operable to support a means for selecting the first scaling factor based on a difference between the quantity of bits present in the transmission buffer and a second quantity of bits associated with the first TB size, a transmission power associated with the uplink data transmission, a predicted uplink block error rate associated with the uplink data transmission, a transmission power headroom associated with the UE, or any combination thereof.

In some examples, the second TB size is smaller than the first TB size when the uplink data transmission includes a quantity of bits that is less than the first TB size; and the second TB size is greater than the first TB size when the uplink data transmission includes a quantity of bits that is greater than the first TB size.

In some examples, the set of multiple scaling factors include a first subset of scaling factors that reduce the first TB size, a second subset of scaling factors that increase the first TB size, or both.

In some examples, the uplink grant indicates that the UE is not enabled to adjust the first TB size for the uplink data transmission. In some examples, the second TB size is equal to the first TB size.

In some examples, the first TB size is determined according to one or more parameters indicated in the uplink grant, the one or more parameters including one or more time domain resources, one or more frequency domain resources, a modulation order, a coding rate, a MIMO layer, or any combination thereof.

In some examples, to support application of the first scaling factor, the TB management component 545 is capable of, configured to, or operable to support a means for modifying a coding rate, a quantity of resource elements, or both, associated with the first TB size in accordance with the first scaling factor while retaining one or more parameters indicated in the uplink grant, the one or more parameters comprising one or more time domain resources, one or more frequency domain resources, a modulation order, a MIMO layer, or any combination thereof.

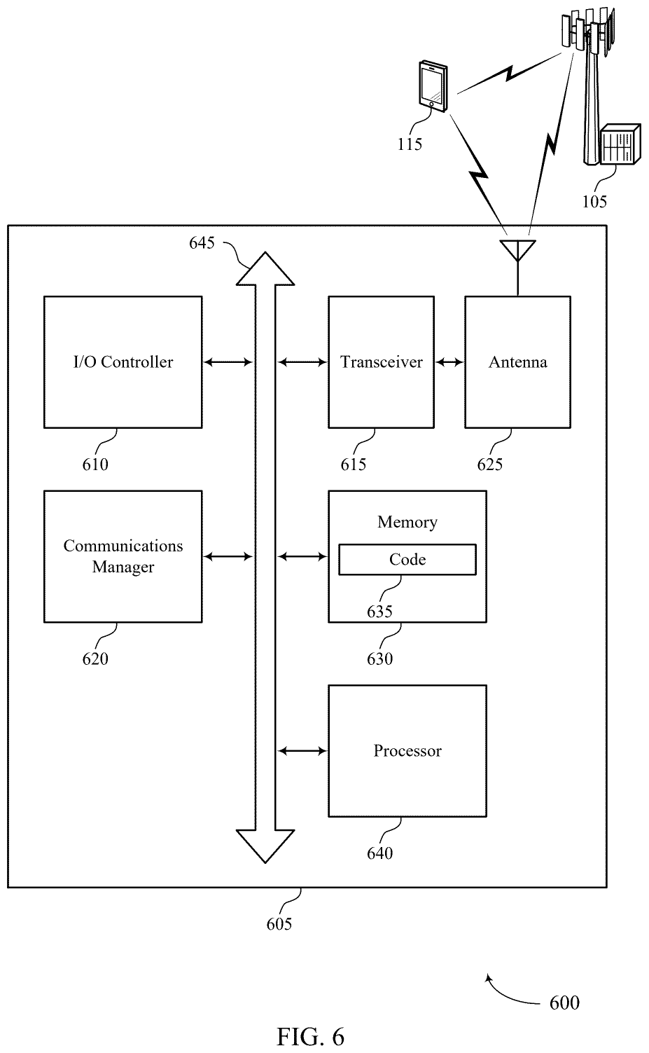

FIG. 6 shows a diagram of a system 600 including a device 605 that supports flexible TB size for uplink grants in accordance with one or more aspects of the present disclosure. The device 605 may be an example of or include components of a device 305, a device 405, or a UE 115 as described herein. The device 605 may communicate (e.g., wirelessly) with one or more other devices (e.g., network entities 105, UEs 115, or a combination thereof). The device 605 may include components for bi-directional voice and data communications including components for transmitting and receiving communications, such as a communications manager 620, an input/output (I/O) controller, such as an I/O controller 610, a transceiver 615, one or more antennas 625, at least one memory 630, code 635, and at least one processor 640. These components may be in electronic communication or otherwise coupled (e.g., operatively, communicatively, functionally, electronically, electrically) via one or more buses (e.g., a bus 645).

The I/O controller 610 may manage input and output signals for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. Additionally, or alternatively, the I/O controller 610 may represent or interact with a modem, a keyboard, a mouse, a touchscreen, or a similar device. In some cases, the I/O controller 610 may be implemented as part of one or more processors, such as the at least one processor 640. In some cases, a user may interact with the device 605 via the I/O controller 610 or via hardware components controlled by the I/O controller 610.

In some cases, the device 605 may include a single antenna. However, in some other cases, the device 605 may have more than one antenna, which may be capable of concurrently transmitting or receiving multiple wireless transmissions. The transceiver 615 may communicate bi-directionally via the one or more antennas 625 using wired or wireless links as described herein. For example, the transceiver 615 may represent a wireless transceiver and may communicate bi-directionally with another wireless transceiver. The transceiver 615 may also include a modem to modulate the packets, to provide the modulated packets to one or more antennas 625 for transmission, and to demodulate packets received from the one or more antennas 625. The transceiver 615, or the transceiver 615 and one or more antennas 625, may be an example of a transmitter 315, a transmitter 415, a receiver 310, a receiver 410, or any combination thereof or component thereof, as described herein.

The at least one memory 630 may include random access memory (RAM) and read-only memory (ROM). The at least one memory 630 may store computer-readable, computer-executable, or processor-executable code, such as the code 635. The code 635 may include instructions that, when executed by the at least one processor 640, cause the device 605 to perform various functions described herein. The code 635 may be stored in a non-transitory computer-readable medium such as system memory or another type of memory. In some cases, the code 635 may not be directly executable by the at least one processor 640 but may cause a computer (e.g., when compiled and executed) to perform functions described herein. In some cases, the at least one memory 630 may include, among other things, a basic I/O system (BIOS) which may control basic hardware or software operation such as the interaction with peripheral components or devices.

The at least one processor 640 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 640 may be configured to operate a memory array using a memory controller. In some other cases, a memory controller may be integrated into the at least one processor 640. The at least one processor 640 may be configured to execute computer-readable instructions stored in a memory (e.g., the at least one memory 630) to cause the device 605 to perform various functions (e.g., functions or tasks supporting flexible TB size for uplink grants). For example, the device 605 or a component of the device 605 may include at least one processor 640 and at least one memory 630 coupled with or to the at least one processor 640, the at least one processor 640 and the at least one memory 630 configured to perform various functions described herein.

In some examples, the at least one processor 640 may include multiple processors and the at least one memory 630 may include multiple memories. One or more of the multiple processors may be coupled with one or more of the multiple memories, which may, individually or collectively, be configured to perform various functions described herein. In some examples, the at least one processor 640 may be a component of a processing system, which may refer to a system (such as a series) of machines, circuitry (including, for example, one or both of processor circuitry (which may include the at least one processor 640) and memory circuitry (which may include the at least one memory 630)), or components, that receives or obtains inputs and processes the inputs to produce, generate, or obtain a set of outputs. The processing system may be configured to perform one or more of the functions described herein. For example, the at least one processor 640 or a processing system including the at least one processor 640 may be configured to, configurable to, or operable to cause the device 605 to perform one or more of the functions described herein. Further, as described herein, being “configured to,” being “configurable to,” and being “operable to” may be used interchangeably and may be associated with a capability, when executing code 635 (e.g., processor-executable code) stored in the at least one memory 630 or otherwise, to perform one or more of the functions described herein.

The communications manager 620 may support wireless communications in accordance with examples as disclosed herein. For example, the communications manager 620 is capable of, configured to, or operable to support a means for transmitting a capability report that indicates a capability of the UE to dynamically adjust a TB size for an uplink data transmission. The communications manager 620 is capable of, configured to, or operable to support a means for receiving, based on transmission of the capability report, a message that indicates a set of multiple scaling factors that are applicable to scale a first TB size. The communications manager 620 is capable of, configured to, or operable to support a means for receiving an uplink grant that schedules the uplink data transmission in accordance with the first TB size and that indicates whether the UE is enabled to adjust the first TB size for the uplink data transmission. The communications manager 620 is capable of, configured to, or operable to support a means for transmitting the uplink data transmission in accordance with a second TB size, where the second TB size is based on application of a first scaling factor of the set of multiple scaling factors to the first TB size.

By including or configuring the communications manager 620 in accordance with examples as described herein, the device 605 may support techniques for reduced signaling overhead and uplink interference and increased uplink throughput, thereby improving overall performance of uplink communications.

In some examples, the communications manager 620 may be configured to perform various operations (e.g., receiving, monitoring, transmitting) using or otherwise in cooperation with the transceiver 615, the one or more antennas 625, or any combination thereof. Although the communications manager 620 is illustrated as a separate component, in some examples, one or more functions described with reference to the communications manager 620 may be supported by or performed by the at least one processor 640, the at least one memory 630, the code 635, or any combination thereof. For example, the code 635 may include instructions executable by the at least one processor 640 to cause the device 605 to perform various aspects of flexible TB size for uplink grants as described herein, or the at least one processor 640 and the at least one memory 630 may be otherwise configured to, individually or collectively, perform or support such operations.

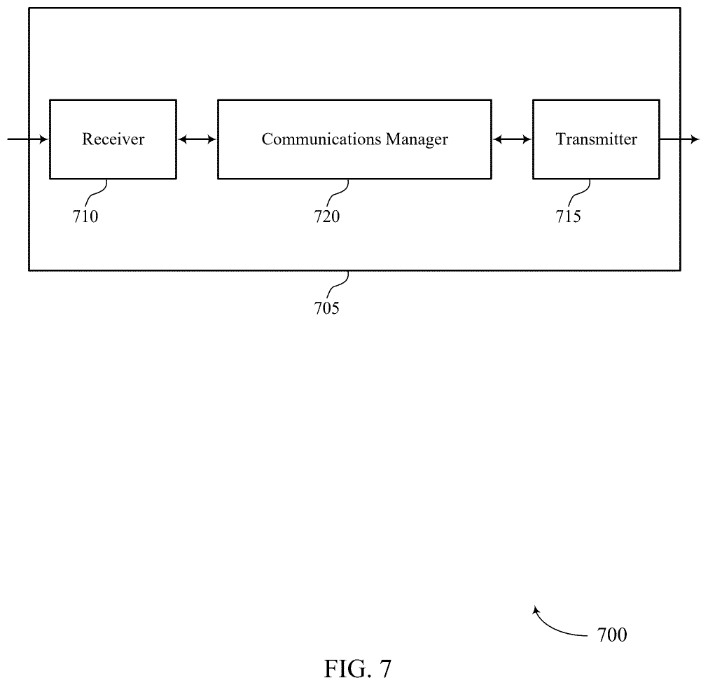

FIG. 7 shows a block diagram 700 of a device 705 that supports flexible TB size for uplink grants in accordance with one or more aspects of the present disclosure. The device 705 may be an example of aspects of a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations or components thereof may be examples of means for performing various aspects of flexible TB size for uplink grants as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for obtaining, from a UE, a capability report that indicates a capability of the UE to dynamically adjust a TB size for an uplink data transmission. The communications manager 720 is capable of, configured to, or operable to support a means for outputting, based on acquisition of the capability report, a message that indicates a set of multiple scaling factors that are applicable to scale a first TB size. In some cases, the message may be output in response to obtaining the report. The communications manager 720 is capable of, configured to, or operable to support a means for outputting an uplink grant that schedules the uplink data transmission in accordance with the first TB size and that indicates whether the UE is enabled to adjust the first TB size for the uplink data transmission. The communications manager 720 is capable of, configured to, or operable to support a means for obtaining the uplink data transmission in accordance with a second TB size, where the second TB size is based on application, by the UE, of a first scaling factor of the set of multiple scaling factors to the first TB size.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced signaling overhead and uplink interference and increased uplink throughput, thereby improving overall performance of uplink communications.

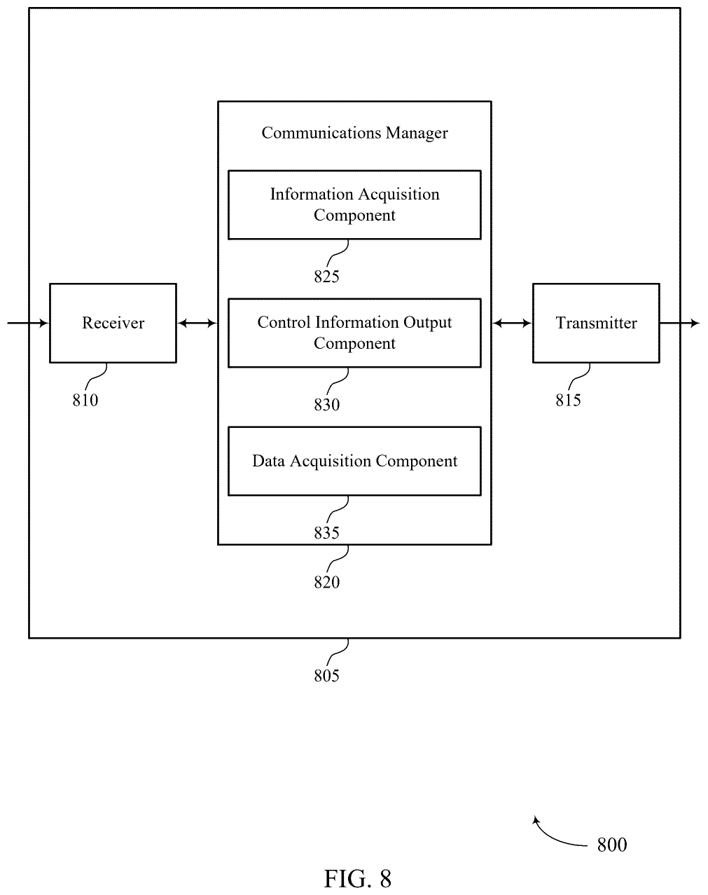

FIG. 8 shows a block diagram 800 of a device 805 that supports flexible TB size for uplink grants in accordance with one or more aspects of the present disclosure. The device 805 may be an example of aspects of a device 705 or a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

Further, various components of the device 805 may provide means for performing the methods described herein. In some examples, means for transmitting and/or receiving may include the transceivers and/or antenna(s) of the device 805. In some examples, means for outputting or sending (such as means for outputting for transmission) and means for obtaining (such as means for obtaining after information is received from a different device) may include one or more interfaces of the 805 to output signals to other components or obtain signals from other components of the device 805. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like.

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of flexible TB size for uplink grants as described herein. For example, the communications manager 820 may include an information acquisition component 825, a control information output component 830, a data acquisition component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The information acquisition component 825 is capable of, configured to, or operable to support a means for obtaining, from a UE, a capability report that indicates a capability of the UE to dynamically adjust a TB size for an uplink data transmission. The control information output component 830 is capable of, configured to, or operable to support a means for outputting, based on acquisition of the capability report, a message that indicates a set of multiple scaling factors that are applicable to scale a first TB size. The control information output component 830 is capable of, configured to, or operable to support a means for outputting an uplink grant that schedules the uplink data transmission in accordance with the first TB size and that indicates whether the UE is enabled to adjust the first TB size for the uplink data transmission. The data acquisition component 835 is capable of, configured to, or operable to support a means for obtaining the uplink data transmission in accordance with a second TB size, where the second TB size is based on application, by the UE, of a first scaling factor of the set of multiple scaling factors to the first TB size.

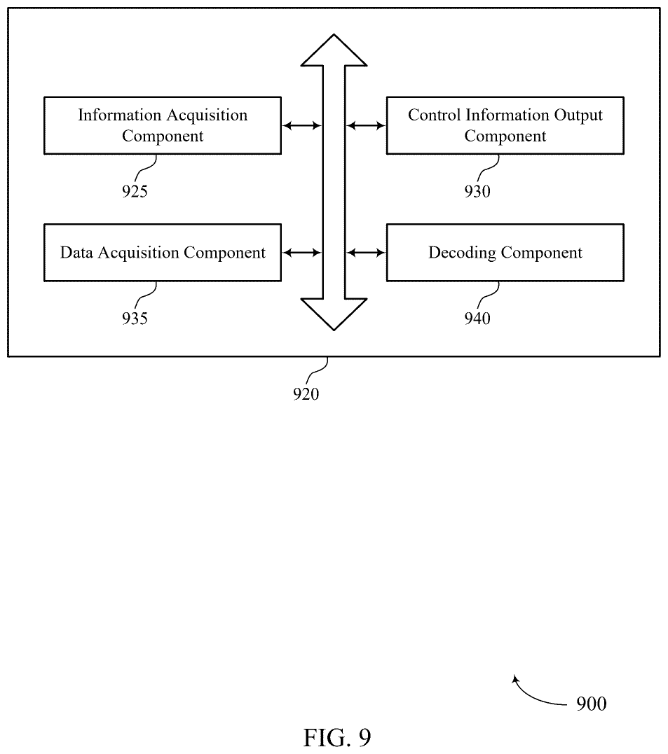

FIG. 9 shows a block diagram 900 of a communications manager 920 that supports flexible TB size for uplink grants in accordance with one or more aspects of the present disclosure. The communications manager 920 may be an example of aspects of a communications manager 720, a communications manager 820, or both, as described herein. The communications manager 920, or various components thereof, may be an example of means for performing various aspects of flexible TB size for uplink grants as described herein. For example, the communications manager 920 may include an information acquisition component 925, a control information output component 930, a data acquisition component 935, a decoding component 940, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communications in accordance with examples as disclosed herein. The information acquisition component 925 is capable of, configured to, or operable to support a means for obtaining, from a UE, a capability report that indicates a capability of the UE to dynamically adjust a TB size for an uplink data transmission. The control information output component 930 is capable of, configured to, or operable to support a means for outputting, based on acquisition of the capability report, a message that indicates a set of multiple scaling factors that are applicable to scale a first TB size. In some examples, the control information output component 930 is capable of, configured to, or operable to support a means for outputting an uplink grant that schedules the uplink data transmission in accordance with the first TB size and that indicates whether the UE is enabled to adjust the first TB size for the uplink data transmission. The data acquisition component 935 is capable of, configured to, or operable to support a means for obtaining the uplink data transmission in accordance with a second TB size, where the second TB size is based on application, by the UE, of a first scaling factor of the set of multiple scaling factors to the first TB size.

In some examples, to support obtaining the uplink data transmission, the data acquisition component 935 is capable of, configured to, or operable to support a means for obtaining the uplink data transmission multiplexed with uplink control information, or punctured by the uplink control information, where the uplink control information indicates the first scaling factor.

In some examples, to support obtaining the uplink data transmission, the decoding component 940 is capable of, configured to, or operable to support a means for decoding the uplink control information to identify the first scaling factor. In some examples, to support obtaining the uplink data transmission, the decoding component 940 is capable of, configured to, or operable to support a means for decoding the uplink data transmission in accordance with the second TB size based on identifying the first scaling factor.

In some examples, the uplink grant indicates that the UE is enabled to adjust the first TB size for the uplink data transmission based on satisfaction of a threshold value by a percentage of padding bits included in one or more previous uplink data transmissions.

In some examples, the second TB size is smaller than the first TB size when the uplink data transmission includes a quantity of bits that is less than the first TB size; and the second TB size is greater than the first TB size when the uplink data transmission includes a quantity of bits that is greater than the first TB size. In some examples, the message is a radio resource control message.

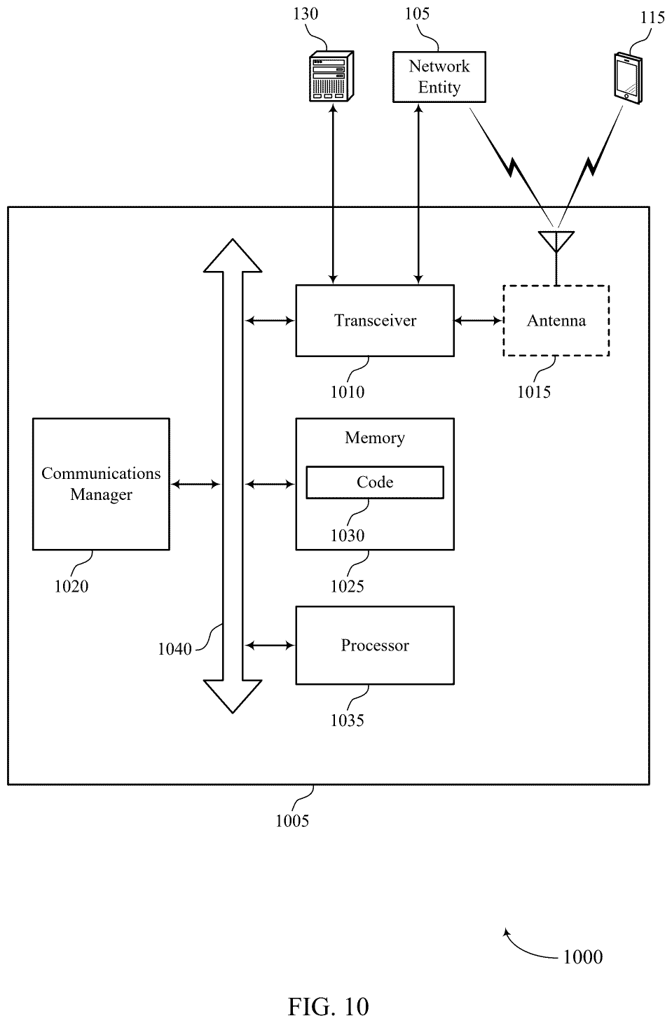

FIG. 10 shows a diagram of a system 1000 including a device 1005 that supports flexible TB size for uplink grants in accordance with one or more aspects of the present disclosure. The device 1005 may be an example of or include components of a device 705, a device 805, or a network entity 105 as described herein. The device 1005 may communicate with other network devices or network equipment such as one or more of the network entities 105, UEs 115, or any combination thereof. The communications may include communications over one or more wired interfaces, over one or more wireless interfaces, or any combination thereof. The device 1005 may include components that support outputting and obtaining communications, such as a communications manager 1020, a transceiver 1010, one or more antennas 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., communication link(s) 125, backhaul communication link(s) 120, a midhaul communication link 162, a fronthaul communication link 168).

The at least one memory 1025 may include RAM, ROM, or any combination thereof. The at least one memory 1025 may store computer-readable, computer- executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may include, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting flexible TB size for uplink grants). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005. The at least one processor 1035 may be any one or more suitable processors capable of executing scripts or instructions of one or more software programs stored in the device 1005 (such as within one or more of the at least one memory 1025).

In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with one or more other network entities 105, and may include a controller or scheduler for controlling communications with UEs 115 (e.g., in cooperation with the one or more other network devices). In some examples, the communications manager 1020 may support an X2 interface within an LTE/LTE-A wireless communications network technology to provide communication between network entities 105.

The communications manager 1020 may support wireless communications in accordance with examples as disclosed herein. For example, the communications manager 1020 is capable of, configured to, or operable to support a means for obtaining, from a UE, a capability report that indicates a capability of the UE to dynamically adjust a TB size for an uplink data transmission. The communications manager 1020 is capable of, configured to, or operable to support a means for outputting, based on acquisition of the capability report, a message that indicates a set of multiple scaling factors that are applicable to scale a first TB size. The communications manager 1020 is capable of, configured to, or operable to support a means for outputting an uplink grant that schedules the uplink data transmission in accordance with the first TB size and that indicates whether the UE is enabled to adjust the first TB size for the uplink data transmission. The communications manager 1020 is capable of, configured to, or operable to support a means for obtaining the uplink data transmission in accordance with a second TB size, where the second TB size is based on application, by the UE, of a first scaling factor of the set of multiple scaling factors to the first TB size.

By including or configuring the communications manager 1020 in accordance with examples as described herein, the device 1005 may support techniques for reduced signaling overhead and uplink interference and increased uplink throughput, thereby improving overall performance of uplink communications.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of flexible TB size for uplink grants as described herein, or the at least one processor 1035 and the at least one memory 1025 may be otherwise configured to, individually or collectively, perform or support such operations.

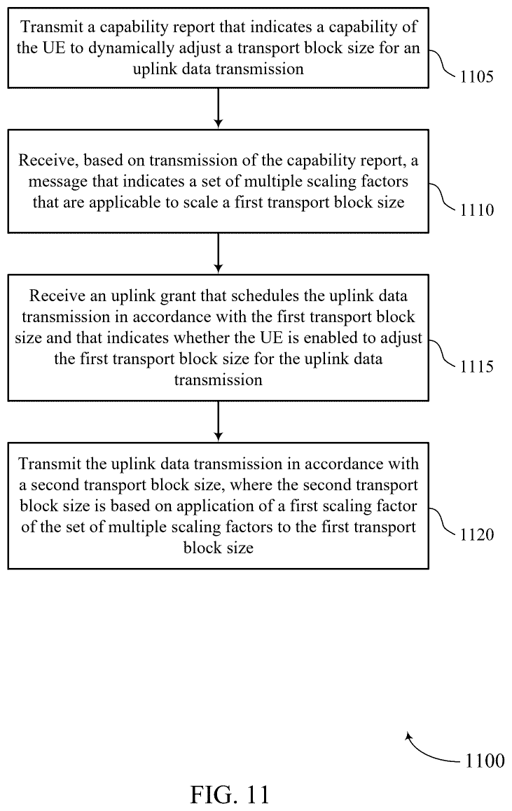

FIG. 11 shows a flowchart illustrating a method 1100 that supports flexible TB size for uplink grants in accordance with one or more aspects of the present disclosure. The operations of the method 1100 may be implemented by a UE or its components as described herein. For example, the operations of the method 1100 may be performed by a UE 115 as described with reference to FIGS. 1 through 6. In some examples, a UE may execute a set of instructions to control the functional elements of the UE to perform the described functions. Additionally, or alternatively, the UE may perform aspects of the described functions using special-purpose hardware.

At 1105, the method may include transmitting a capability report that indicates a capability of the UE to dynamically adjust a TB size for an uplink data transmission. The operations of 1105 may be performed in accordance with examples as disclosed herein. In some examples, aspects of the operations of 1105 may be performed by an information transmission component 525 as described with reference to FIG. 5.

At 1110, the method may include receiving, based on transmission of the capability report, a message that indicates a set of multiple scaling factors that are applicable to scale a first TB size. The operations of 1110 may be performed in accordance with examples as disclosed herein. In some examples, aspects of the operations of 1110 may be performed by a control information reception component 530 as described with reference to FIG. 5.

At 1115, the method may include receiving an uplink grant that schedules the uplink data transmission in accordance with the first TB size and that indicates whether the UE is enabled to adjust the first TB size for the uplink data transmission. The operations of 1115 may be performed in accordance with examples as disclosed herein. In some examples, aspects of the operations of 1115 may be performed by a control information reception component 530 as described with reference to FIG. 5.

At 1120, the method may include transmitting the uplink data transmission in accordance with a second TB size, where the second TB size is based on application of a first scaling factor of the set of multiple scaling factors to the first TB size. The operations of 1120 may be performed in accordance with examples as disclosed herein. In some examples, aspects of the operations of 1120 may be performed by a data transmission component 535 as described with reference to FIG. 5.

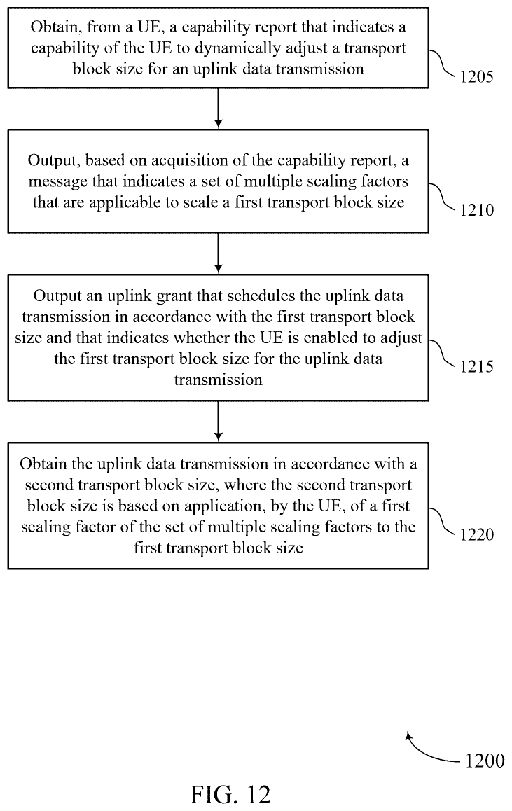

FIG. 12 shows a flowchart illustrating a method 1200 that supports flexible TB size for uplink grants in accordance with one or more aspects of the present disclosure. The operations of the method 1200 may be implemented by a network entity or its components as described herein. For example, the operations of the method 1200 may be performed by a network entity as described with reference to FIGS. 1 and 7 through 10. In some examples, a network entity may execute a set of instructions to control the functional elements of the network entity to perform the described functions. Additionally, or alternatively, the network entity may perform aspects of the described functions using special-purpose hardware.

At 1205, the method may include obtaining, from a UE, a capability report that indicates a capability of the UE to dynamically adjust a TB size for an uplink data transmission. The operations of 1205 may be performed in accordance with examples as disclosed herein. In some examples, aspects of the operations of 1205 may be performed by an information acquisition component 825 as described with reference to FIG. 8.

At 1210, the method may include outputting, based on acquisition of the capability report, a message that indicates a set of multiple scaling factors that are applicable to scale a first TB size. The operations of 1210 may be performed in accordance with examples as disclosed herein. In some examples, aspects of the operations of 1210 may be performed by a control information output component 830 as described with reference to FIG. 8.

At 1215, the method may include outputting an uplink grant that schedules the uplink data transmission in accordance with the first TB size and that indicates whether the UE is enabled to adjust the first TB size for the uplink data transmission. The operations of 1215 may be performed in accordance with examples as disclosed herein. In some examples, aspects of the operations of 1215 may be performed by a control information output component 830 as described with reference to FIG. 8.

At 1220, the method may include obtaining the uplink data transmission in accordance with a second TB size, where the second TB size is based on application, by the UE, of a first scaling factor of the set of multiple scaling factors to the first TB size. The operations of 1220 may be performed in accordance with examples as disclosed herein. In some examples, aspects of the operations of 1220 may be performed by a data acquisition component 835 as described with reference to FIG. 8.

The following provides an overview of aspects of the present disclosure:

Aspect 1: A method for wireless communications at a wireless node, comprising: outputting a report that indicates a capability to adjust a transport block size of data; obtaining a grant that schedules the data for transmission via a first transport block size and that indicates whether the first transport block size is adjustable; applying a first scaling factor of the plurality of scaling factors to the first transport block size to obtain a second transport block size; and outputting the data for transmission via the second transport block size.

Aspect 2: The method of aspect 1, wherein outputting the data comprises: multiplexing control information with the data, wherein the data and the control information are outputted for transmission via the second transport block size, or puncturing or multiplexing the control information onto the data, wherein the control information indicates the first scaling factor and the data and the control information are outputted for transmission via the second transport block size.

Aspect 3: The method of any of aspects 1 through 2, further comprising: selecting the first scaling factor based on a quantity of bits present in a transmission buffer.

Aspect 4: The method of aspect 3, wherein the first scaling factor is selected based on a difference between the quantity of bits present in the transmission buffer and a second quantity of bits associated with the first transport block size.

Aspect 5: The method of any of aspects 1 through 4, wherein the first scaling factor is selected further based on at least one of: a transmission power associated with the data, an uplink block error rate associated with the data, or a transmission power headroom.

Aspect 6: The method of any of aspects 1 through 5, wherein at least one of the second transport block size is smaller than the first transport block size when the data comprises a quantity of bits that is less than the first transport block size; or the second transport block size is greater than the first transport block size when the data comprises a quantity of bits that is greater than the first transport block size.

Aspect 7: The method of any of aspects 1 through 6, wherein the plurality of scaling factors comprise a first subset of scaling factors configured to reduce the first transport block size or a second subset of scaling factors configured to increase the first transport block size.

Aspect 8: The method of any of aspects 1 through 7, wherein the first transport block size is based on one or more parameters indicated in the grant, the one or more parameters comprising one or more time domain resources, one or more frequency domain resources, a modulation order, a coding rate, a multiple-in multiple-out layer, or any combination thereof.

Aspect 9: The method of any of aspects 1 through 8, wherein the applying the first scaling factor comprises: modifying a coding rate, a quantity of resource elements, or both that are associated with the first transport block size, the modification being based on the first scaling factor.

Aspect 10: The method of aspect 9, further comprising: using one or more parameters included in the grant to output the data while modifying the coding rate, the quantity of resource elements or both.

Aspect 11: The method of aspect 8, wherein the one or more parameters comprise one or more time domain resources, one or more frequency domain resources, a modulation order, a multiple-in multiple-out layer, or any combination thereof.

Aspect 12: A wireless node (e.g., a UE), including one or more transceivers, and a processing system that includes processor circuitry and memory circuitry that stores code, the processing system configured to cause the wireless node to perform the method of any of aspects 1 through 11, wherein the one or more transceivers are configured to transmit the report and the data and receive the grant.

Aspect 13: An apparatus for wireless communication, including a processing system that includes processor circuitry and memory circuitry that stores code, the processing system configured to cause the apparatus to perform the method of any of aspects 1 through 11.

Aspect 14: An apparatus for wireless communication, comprising at least one means for performing a method of any of aspects 1 through 11.

Aspect 15: A non-transitory computer-readable medium storing code for wireless communication, the code comprising instructions executable by one or more processors to perform a method of any of aspects 1 through 11.

Aspect 16: A method for wireless communications at a wireless node, comprising: obtaining a report that indicates a capability to adjust a transport block size of data; outputting, after obtaining the report, a message that indicates a plurality of scaling factors; outputting a grant that schedules the data for transmission via a first transport block size and that indicates whether the first transport block size is adjustable; and obtaining the data via a second transport block size that is based on application of a first scaling factor of the plurality of scaling factors to the first transport block size.

Aspect 17: The method of aspect 16, wherein at least one of: the second transport block size is smaller than the first transport block size when the data comprises a quantity of bits that is less than the first transport block size; or the second transport block size is greater than the first transport block size when the data comprises a quantity of bits that is greater than the first transport block size.

Aspect 18: The method of any of aspects 16 and 17, wherein the plurality of scaling factors comprise a first subset of scaling factors configured to reduce the first transport block size or a second subset of scaling factors configured to increase the first transport block size.

Aspect 19: The method of any of aspects 16 through 18, wherein the first transport block size is based on one or more parameters indicated in the grant, the one or more parameters comprising one or more time domain resources, one or more frequency domain resources, a modulation order, a coding rate, a multiple-in multiple-out layer, or any combination thereof.

Aspect 20: The method of any of aspects 16 through 19, further comprising: decoding the data based on the first scaling factor.

Aspect 21: The method of any of aspects 16 through 20, further comprising: demultiplexing control information from the data after obtaining the data via the second transport block size, or extracting the control information from the data after obtaining the data via the second transport block size, wherein the control information indicates the first scaling factor.

Aspect 20: A wireless node (e.g., a network entity), including one or more transceivers, and a processing system that includes processor circuitry and memory circuitry that stores code, the processing system configured to cause the wireless node to perform the method of any of aspects 16 through 19, wherein the one or more transceivers are configured to receive the report and the data and transmit the message and the grant.

Aspect 21: An apparatus for wireless communication, including a processing system that includes processor circuitry and memory circuitry that stores code, the processing system configured to cause the apparatus to perform the method of any of aspects 16 through 19.

Aspect 22: An apparatus for wireless communication, comprising at least one means for performing a method of any of aspects 16 through 19.

Aspect 23: A non-transitory computer-readable medium storing code for wireless communication, the code comprising instructions executable by one or more processors to perform a method of any of aspects 16 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, a singular noun is not to be construed as being limited to a single item but may refer to one or more items. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications, comprising:
a processing system that includes processor circuitry and memory circuitry that stores code, the processing system configured to cause the apparatus to:
output a report that indicates a capability to adjust a transport block size of data;
obtain a grant that schedules the data for transmission via a first transport block size and that indicates whether the first transport block size is adjustable;
apply a first scaling factor of the plurality of scaling factors to the first transport block size to obtain a second transport block size; and
output the data for transmission via the second transport block size.

2. The apparatus of claim 1, wherein, to output the data, the processing system is configured to cause the apparatus to:
multiplex control information with the data, wherein the data and the control information are outputted for transmission via the second transport block size, or
puncture or multiplex the control information onto the data, wherein the control information indicates the first scaling factor and the data and the control information are outputted for transmission via the second transport block size.

3. The apparatus of claim 1, wherein the processing system is further configured to cause the apparatus to:
select the first scaling factor based on a quantity of bits present in a transmission buffer.

4. The apparatus of claim 3, wherein the first scaling factor is selected based on a difference between the quantity of bits present in the transmission buffer and a second quantity of bits associated with the first transport block size.

5. The apparatus of claim 3, wherein the first scaling factor is selected further based on at least one of:
a transmission power associated with the data,
an uplink block error rate associated with the data, or
a transmission power headroom.

6. The apparatus of claim 1, wherein at least one of:
the second transport block size is smaller than the first transport block size when the data comprises a quantity of bits that is less than the first transport block size; or
the second transport block size is greater than the first transport block size when the data comprises a quantity of bits that is greater than the first transport block size.

7. The apparatus of claim 1, wherein the plurality of scaling factors comprise a first subset of scaling factors configured to reduce the first transport block size or a second subset of scaling factors configured to increase the first transport block size.

8. The apparatus of claim 1, wherein the first transport block size is based on one or more parameters indicated in the grant, the one or more parameters comprising one or more time domain resources, one or more frequency domain resources, a modulation order, a coding rate, a multiple-in multiple-out layer, or any combination thereof.

9. The apparatus of claim 1, wherein, to apply the first scaling factor, the processing system is configured to cause the apparatus to:
modify a coding rate, a quantity of resource elements, or both that are associated with the first transport block size, the modification being based on the first scaling factor.

10. The apparatus of claim 9, wherein the processing system is further configured to cause the apparatus to:
use one or more parameters included in the grant to output the data while modifying the coding rate, the quantity of resource elements or both.

11. The apparatus of claim 8, wherein the one or more parameters comprise one or more time domain resources, one or more frequency domain resources, a modulation order, a multiple-in multiple-out layer, or any combination thereof.

12. The apparatus of claim 1, further comprising:
one or more transceivers configured to transmit the report, receive the message, receive the grant, and transmit the data, wherein the apparatus is configured as a user equipment (UE).

13. An apparatus for wireless communications, comprising:
a processing system that includes processor circuitry and memory circuitry that stores code, the processing system configured to cause the apparatus to:
obtain a report that indicates a capability to adjust a transport block size of data;
output, after obtaining the report, a message that indicates a plurality of scaling factors;
output a grant that schedules the data for transmission via a first transport block size and that indicates whether the first transport block size is adjustable; and
obtain the data via a second transport block size that is based on application of a first scaling factor of the plurality of scaling factors to the first transport block size.

14. The apparatus of claim 13, wherein at least one of:
the second transport block size is smaller than the first transport block size when the data comprises a quantity of bits that is less than the first transport block size; or
the second transport block size is greater than the first transport block size when the data comprises a quantity of bits that is greater than the first transport block size.

15. The apparatus of claim 13, wherein the plurality of scaling factors comprise a first subset of scaling factors configured to reduce the first transport block size or a second subset of scaling factors configured to increase the first transport block size.

16. The apparatus of claim 13, wherein the first transport block size is based on one or more parameters indicated in the grant, the one or more parameters comprising one or more time domain resources, one or more frequency domain resources, a modulation order, a coding rate, a multiple-in multiple-out layer, or any combination thereof.

17. The apparatus of claim 13, further comprising:
one or more transceivers configured to receive the report, transmit the message, transmit the grant, and receive the data, wherein the apparatus is configured as a network entity.

18. A method for wireless communications at a wireless node, comprising:
outputting a report that indicates a capability to adjust a transport block size of data;
obtaining a grant that schedules the data for transmission via a first transport block size and that indicates whether the first transport block size is adjustable;
applying a first scaling factor of the plurality of scaling factors to the first transport block size to obtain a second transport block size; and
outputting the data for transmission via the second transport block size.

19. The method of claim 18, wherein outputting the data comprises:
multiplexing control information with the data, wherein the data and the control information are outputted for transmission via the second transport block size, or
puncturing or multiplexing the control information onto the data, wherein the control information indicates the first scaling factor and the data and the control information are outputted for transmission via the second transport block size.

20. The method of claim 18, further comprising:
selecting the first scaling factor based on a quantity of bits present in a transmission buffer.
